(19) United States
(12) Patent Application Publication
(10) Pub. No.: US 2007/0230841 A1
(43) Pub. Date: Oct. 4, 2007

(54) Hydrodynamic bearing device, motor, recording and reproducing apparatus, and machining jig

(76) Inventors: Hisaaki Yano, Ehime (JP); Fusatoshi Okamoto, Ehime (JP)

Correspondence Address: WENDEROTH, LIND & PONACK L.L.P., 2033 K. STREET, NW, SUITE 800, WASHINGTON, DC, 20006, US

(21) Appl. No.: 11/641,729

(22) Filed: Dec. 20, 2006

(30) Foreign Application Priority Data
Mar. 30, 2006 (JP) 2006-093554

(51) Int. Cl. B21D 53/10; F16C 17/00; G01D 15/24; H02K 1/06; H02K 1/22

(52) U.S. Cl. 384/110; 29/898.02; 310/40 R; 346/137; 384/113

(57) ABSTRACT

A fluid bearing device 40 comprises a sleeve 1, a shaft 2, a thrust plate 4, a radial bearing component 21, and a thrust bearing component 22. A bearing hole 1a is formed in the sleeve 1. The shaft 2 has a shaft main component 5 that is inserted in the bearing hole 1a, and a flange 3 provided on the axial lower side of the shaft main component 5. The thrust plate 4 is fixed to the sleeve 1 and covers the shaft 2 from the axial lower side. A screw hole 5a that is coaxial with the shaft main component 5 is formed in the shaft main component 5 from the end face on the axial upper side toward the axial lower side. An annular concave component 3c that is coaxial with the shaft 2 is formed in the end face on the axial lower side of the shaft 2.

### BACKGROUND OF THE INVENTION

1. Field of the Invention

The present invention relates to a hydrodynamic bearing device, and more particularly to a rotating shaft type of hydrodynamic bearing device, and to a motor and a recording and reproducing apparatus equipped with this bearing device, and to a jig for machining the constitution parts of a hydrodynamic bearing device.

2. Description of the Prior Art

Hard disk drives (hereinafter referred to as HDDs) are used not only in personal computers, but also in portable music players, portable telephones, and so forth. Therefore, HDDs and the spindle motors installed in HDDs need to have impact resistance and other such characteristics in addition to being made thinner and smaller.

The spindle motors used in HDDs generally come in two types: a fixed shaft type and a rotating shaft type. Spindle motors of the type with the shaft fixed at both ends, in which the housing of the HDD is fixed to both ends of a fixed shaft, are most often used, particularly with smaller HDDs. This is because this both-end-fixed shaft type allows force in the axial direction to be received by the fixed shaft, so the structure is more resistant to force in the axial direction and is better suited to portable applications. With a both-end-fixed shaft type, an annular clamping member is usually screwed to a hub at a plurality of places in the peripheral direction in order to attach a disk to the hub, which is fixed to the sleeve on the rotation side. In this case, since the clamping member is screwed to the hub at a plurality of places in the peripheral direction, the clamping force applied by the clamping member to the disk tends not to be uniform in the peripheral direction, and this tends to result in disk deformation.

With a rotating type, meanwhile, a threaded hole is made in the center of the shaft on the rotation side, so that a clamping member can be attached to this threaded hole. In this case, since the clamping member can be fixed at one location in the center, the clamping force exerted by the clamping member on the disk tends to be more uniform in the peripheral direction, so disk deformation can be minimized. Accordingly, rotating-type bearing devices are often employed in small HDDs in which disk deformation needs to be suppressed better.

The structures discussed in Patent Documents 1 to 3 (Japanese Laid-Open Patent Application H6-307435, Japanese Laid-Open Patent Application 2002-227834, Japanese Laid-Open Patent Application 2001-140862) are known as bearing devices of the rotating shaft type. For instance, the structure disclosed in Patent Document 2 makes use of a flanged shaft designed such that a flange is screwed to a shaft main component. There is another known structure in which a flange is fixed to a shaft main component by welding or plastic deformation (such as coining).

However, with a small spindle motor, when a structure is employed in which a flange is separately attached to a shaft main component, there is more strain during welding or the like in the attachment of the flange to the shaft main component, and bearing characteristics suffer. Consequently, a structure in which the flange and the shaft main component are formed integrally is most often employed. FIG. 9 shows a cross section of a shaft with this structure. The shaft 100 shown in FIG. 9 comprises a shaft-shaped shaft main component 101 and a flange 102 integrally provided on one side of the shaft main component 101 in the axial direction. The flange 102 has a larger diameter than the shaft main component 101. Also, a screw hole 104, having a bottomed hole as a pilot hole and for screwing in a clamping member used to clamp a disk, is formed in the shaft main component 101.

Meanwhile, the outer peripheral face 105 of the shaft main component 101 must be precisely ground in order to form a hydrodynamic bearing across from the inner peripheral face of a sleeve. Usually, centerless polishing is performed in the machining of a cylindrical member, but it is generally difficult to perform centerless polishing on the shaft main component 101 because it is formed integrally with the flange 102. Therefore, cylindrical grinding (or cylindrical polishing) is employed. With cylindrical grinding, both axial ends of the shaft 100 are supported and rotated, and the outer peripheral face 105 of the shaft main component 101 is ground with a grindstone rotating at high speed. A center hole 110 is therefore provided to the lower end face 106 of the flange 102.

FIG. 10 shows the state in which the shaft 100 is supported by a headstock center 114 and tailstock center 115 of a grinder during cylindrical grinding. The center hole 110 is formed by an angled portion 112 that is in planar contact with the tailstock center 115, which has a conical tip, and an oil sump 113 into which cutting oil enters. The center angle, which is the opening angle of the center hole 110, may be 60 degrees, 75 degrees, 90 degrees, etc.

### SUMMARY OF THE INVENTION

However, with the shaft 100 structured as above, it is difficult to meet the requirements for compact size and impact resistance of HDDs in recent years. Specifically, while the shaft 100 needs to be made shorter in its axial direction in order to make the HDD thinner and more compact, the screw hole 104 has to be formed in a sufficient length in the axial direction for impact resistance. This is because to increase impact resistance, it is necessary to screw a clamping member to the screw hole 104 of sufficient length, and clamp the disk so that the disk can be adequately supported even when subjected to force during impact. However, if the shaft 100 is shortened in its axial direction while the axial length of the screw hole 104 is maintained or increased, the screw hole 104 and the center hole 110 will end up going all the way through in the axial direction, which means that the lower end of the flange 102 will communicate with the outside air, and this decreases the pressure of the bearing, or the amount of oil in the bearing will decrease to the point that the bearing cannot perform its function, or oil may leak outside the bearing and foul the inside of the HDD.

In view of this, it is an object of the present invention to provide a hydrodynamic bearing device that meets the need for smaller size and good impact resistance, as well as a motor and a recording and reproducing apparatus equipped with this bearing device.

It is another object of the present invention to provide a machining jig that is used to machine a hydrodynamic bearing device that meets the need for smaller size and impact resistance.

The hydrodynamic bearing device of the first invention comprises a sleeve, a shaft, a thrust plate, a radial bearing component, and a thrust bearing component. An insertion hole is formed in the sleeve. The shaft has a shaft main component that is inserted in the insertion hole, and a flange component provided to one side in the axial direction of the shaft main component. The thrust plate is fixed to the sleeve and covers the shaft from the one side in the axial direction. The radial bearing component includes a lubricating fluid that continuously fills in between the sleeve and the shaft and in between the shaft and the thrust plate, and a radial hydrodynamic groove that is formed in the outer peripheral face of the shaft main component and/or in the inner peripheral face of the insertion hole, and that supports the shaft so that the shaft is rotatable relative to the sleeve. The thrust bearing component includes the lubricating fluid that continuously fills in between the sleeve and the shaft and in between the shaft and the thrust plate, and a thrust hydrodynamic groove that is formed in the end face of the shaft on the one side in the axial direction and/or in the end face of the thrust plate on the other side in the axial direction, and that supports the shaft so that the shaft is rotatable relative to the sleeve. A bottomed hole that is coaxial with the shaft main component is formed in the shaft main component from the end face on said other side in the axial direction toward said one side in the axial direction. An annular concave component that is coaxial with the shaft is formed in the end face on said one side in the axial direction of the shaft.

A bottomed hole including the screw hole and/or a pilot hole for the screw hole is formed in the shaft main component from the end face on said other side in the axial direction toward said one side in the axial direction. An annular concave component is formed on said one side in the axial direction of the shaft end face. This functions as a center hole in the cylindrical grinding or cylindrical polishing of the outer peripheral face of the shaft main component. The lubricating fluid continuously fills the clearance between the radial bearing component and the thrust bearing component.

With the hydrodynamic bearing device of the present invention, since an annular concave component is formed in the end face on one axial side of the shaft, the center is not cut in like the center hole, and the center part of the end face on one axial side of the shaft can be thicker. Therefore, enough thickness can be ensured at the bottom part of the bottomed hole even if the length of the bottomed hole in the axial direction is increased. Specifically, by shortening the axial length of the shaft, the device can be made more compact while maintaining or increasing the length of the bottomed hole. Thus, the effective thread length of the clamp threads can be increased, and impact resistance can be maintained or improved.

Also, since enough thickness can be ensured at the bottom part of the bottomed hole, the thrust bearing component can be prevented from communicating with the bottomed hole. Thus, it is possible to prevent the occurrence of problems such as a decrease in the pressure of the thrust bearing component, or a decrease in the amount of oil in the bearing to the point that the bearing cannot perform its function, or leakage of the lubricating fluid outside the bearing and attendant fouling of the inside of the recording and reproducing apparatus in which the hydrodynamic bearing device is installed.

With the hydrodynamic bearing device of the second invention, the inner peripheral face on the radial outside of the annular concave component is an inclined face whose diameter increases toward said one side in the axial direction.

With the hydrodynamic bearing device of the present invention, the inner peripheral face on the radial outside of the annular concave component is formed as an inclined face. Accordingly, when the outer peripheral face of the shaft main component, for example, is cylindrically ground or cylindrically polished, the shaft main component can be supported by a machining jig on the outer peripheral side of the inclined face of the annular concave component, and the outer peripheral face of the shaft main component can be machined while supported more stably.

With the hydrodynamic bearing device of the third invention, a stepped component that is recessed toward said other side in the axial direction is formed to the radial inside of the end face on said one side in the axial direction of the shaft. The annular concave component is formed on the radial inner peripheral side of the stepped component.

With the hydrodynamic bearing device of the present invention, an annular concave component is formed further to the radial inner peripheral side of the stepped component. Accordingly, even if burrs or the like should be left around the edges of the annular concave component in the machining of the annular concave component, it will be possible to prevent these burrs from wearing against the thrust plate and finding their way into the lubricating fluid as abrasion dust.

With the hydrodynamic bearing device of the fourth invention, a convex component that protrudes to said one side in the axial direction, to the radial outside of the annular concave component, is formed on the end face on said one side in the axial direction of the shaft.

With the hydrodynamic bearing device of the present invention, since a convex component is formed on the end face on said one side in the axial direction of the shaft, it is possible to prevent wear between the thrust plate and the shaft in the thrust bearing component during start-up or shut-down.

With the hydrodynamic bearing device of the fifth invention, a bottomed hole is formed in the axial direction in the shaft main component, more toward the end on said one side in the axial direction than a joined portion with the flange component on said one side in the axial direction.

As a result, as discussed above, since no cut is made into the center portion as in the case of a center hole, and an annular concave component is formed in the end face on said one side in the axial direction of the shaft, enough thickness can be ensured at the bottom part of the bottomed hole even if the length of the bottomed hole in the axial direction is increased. As a result, the location of the bottom part of the bottomed hole is moved downward in the axial direction, which shortens the axial length of the shaft itself and allows the device to be made more compact. Also, since the effective thread length of the clamp threads can be increased, impact resistance can be maintained or improved.

The motor of the sixth invention comprises the hydrodynamic bearing device of the first inventions, a base to which the sleeve is fixed, a stator around which is wound a coil that is fixed to the base, a rotor magnet that is disposed across from the stator and constitutes a magnetic circuit along with the stator, and a hub to which the rotor magnet is fixed and which is fixed to the shaft.

With the motor of the present invention, it is possible to obtain the same effect as with the hydrodynamic bearing device of the first inventions.

The recording and reproducing apparatus of the seventh invention comprises the motor of the sixth invention, a disk-shaped recording medium that is fixed to the hub and allows information to be recorded, and information access means for writing or reading information to a specific location of the recording medium.

With the motor of the present invention, it is possible to obtain the same effect as with the motor of the sixth invention.

The machining jig of the eighth invention is a machining jig for supporting a workpiece during the cylindrical cutting or cylindrical polishing of the workpiece, comprising a first-side support component and a second-side support component. The first-side support component has an annular convex component that mates with an annular concave component formed in the end face on said one side in the axial direction of the workpiece, and supports the workpiece from said one side in the axial direction. The second-side support component supports the workpiece from said other side in the axial direction.

With the machining jig of the present invention, the first-side support component has an annular convex component that mates with an annular concave component of the workpiece, and it is possible to support the workpiece more stably. Also, even if the workpiece is a flanged shaft, which makes centerless machining difficult, the outer periphery of the shaft can still be machined.

With the machining jig of the ninth invention, the annular concave component has an inner peripheral inclined face whose diameter increases toward said one side in the axial direction, the annular convex component has an outer peripheral inclined face whose diameter increases toward said one side in the axial direction, and the outer peripheral inclined face has an opening angle that is larger than that of the inner peripheral inclined face.

With the machining jig of the present invention, it is possible to support the inner peripheral inclined face on the outer peripheral side of the outer peripheral inclined face. This makes it possible to support the workpiece more stably.

The hydrodynamic bearing device of the tenth invention comprises a sleeve, a shaft, a thrust plate, a radial bearing component, and a thrust bearing component. An insertion hole is formed in the sleeve. The shaft is inserted into the insertion hole. The thrust plate is fixed to the sleeve and covers the shaft from one side in the axial direction. The radial bearing component includes a lubricating fluid that continuously fills in between the sleeve and the shaft and in between the shaft and the thrust plate, and a radial hydrodynamic groove that is formed in the outer peripheral face of the shaft main component and/or in the inner peripheral face of the insertion hole, and that supports the shaft so that the shaft is rotatable relative to the sleeve. The thrust bearing component includes the lubricating fluid that continuously fills in between the sleeve and the shaft and in between the shaft and the thrust plate, and a thrust hydrodynamic groove that is formed in the end face of the shaft on the one side in the axial direction and/or in the end face of the thrust plate on the other side in the axial direction, and that supports the shaft so that the shaft is rotatable relative to the sleeve. A bottomed hole that is coaxial with the shaft is formed in the shaft from the end face on said other side in the axial direction toward said one side in the axial direction. An annular concave component that is coaxial with the shaft is formed in the end face on said one side in the axial direction of the shaft.

A bottomed hole including the screw hole and/or a pilot hole for the screw hole is formed in the shaft from the end face on said other side in the axial direction toward said one side in the axial direction. An annular concave component is formed on said one side in the axial direction of the shaft end face. This functions as a center hole in the cylindrical grinding or cylindrical polishing of the outer peripheral face of the shaft. The lubricating fluid continuously fills the clearance between the radial bearing component and the thrust bearing component.

With the hydrodynamic bearing device of the present invention, since an annular concave component is formed in the end face on said one side in the axial direction of the shaft, the center is not cut in like the center hole, and the center part of the end face on one axial side of the shaft can be thicker. Therefore, enough thickness can be ensured at the bottom part of the bottomed hole even if the length of the bottomed hole in the axial direction is increased. Specifically, by shortening the axial length of the shaft, the device can be made more compact while maintaining or increasing the length of the bottomed hole. Thus, the effective thread length of the clamp threads can be increased, and impact resistance can be maintained or improved.

Also, since enough thickness can be ensured at the bottom part of the bottomed hole, the thrust bearing component can be prevented from communicating with the bottomed hole. Thus, it is possible to prevent the occurrence of problems such as a decrease in the pressure of the bearing, or a decrease in the amount of oil in the bearing to the point that the bearing cannot perform its function, or leakage of the lubricating fluid outside the bearing and attendant fouling of the inside of the recording and reproducing apparatus in which the hydrodynamic bearing device is installed.

### BRIEF DESCRIPTION OF THE DRAWINGS

FIG. 1 is a cross section of a spindle motor in an embodiment of the present invention;

FIG. 2 is a cross section of a shaft;

FIG. 3 is a cross section of when a shaft has been chucked for cylindrical grinding;

FIG. 4 is a cross section illustrating the effect of the annular concave component;

FIGS. 5a to 5l consist of diagrams illustrating the results of a simulation pertaining to shaft stiffness;

FIG. 6 is a graph of the results of a simulation pertaining to shaft stiffness;

FIG. 7 is a cross section of a shaft in another embodiment;

FIG. 8 is a cross section of the structure of a recording and reproducing apparatus;

FIG. 9 is a cross section of a shaft in prior art; and

FIG. 10 is a cross section of when a shaft is chucked for cylindrical grinding in prior art.

### DETAILED DESCRIPTION OF THE PREFERRED EMBODIMENTS

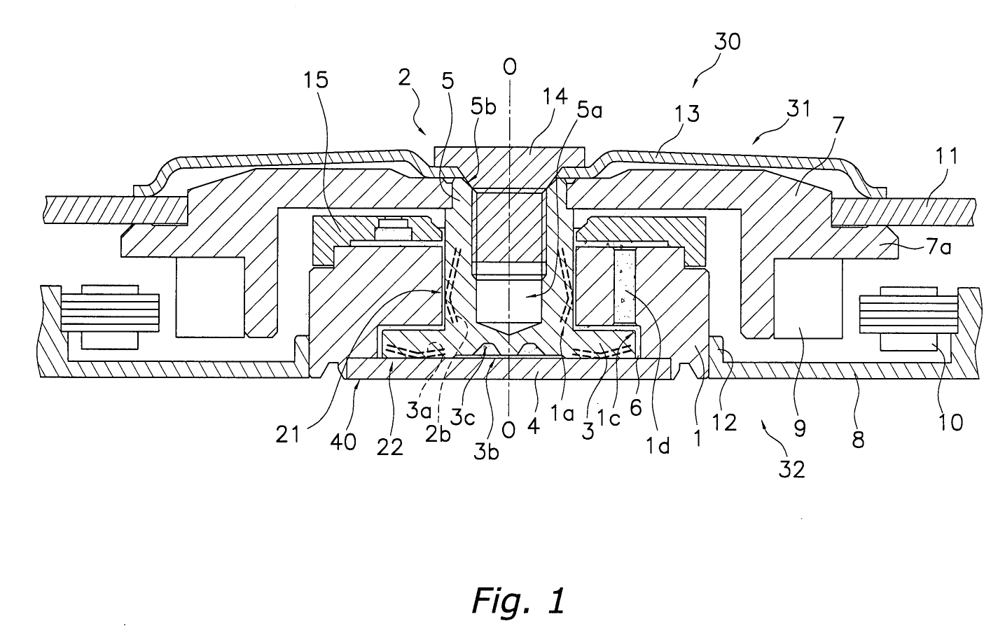

Embodiment of the present invention will be described through reference to FIGS. 1 to 8.

FIG. 1 is a simplified vertical cross section of a spindle motor 30 in an embodiment of the present invention. The O-O line in FIG. 1 is the rotational axis of the spindle motor 30. In the description of this embodiment, the up and down direction in the drawings will be expressed as the “axial upper side,” “axial lower side,” and so forth for the sake of convenience, but these do not limit the actual state of attachment of the spindle motor 30. Also, the terms “one side in the axial direction” and “other side in the axial direction” used in the claims will be referred to as the “axial lower side” and “axial upper side,” respectively.

### Structure of Spindle Motor 30

As shown in FIG. 1, the spindle motor 30 pertaining to this embodiment is a device for rotationally driving a recording disk 11, and primarily comprises a rotating member 31, a stationary member 32, and a fluid bearing device 40.

The rotating member 31 primarily has a hub 7 to which the recording disk 11 is mounted, and a rotor magnet 9.

The hub 7 is a bowl-shaped member that is integrated with a shaft 2 (discussed below) by press-fitting to the shaft 2. Also, the hub 7 is provided by the integral working, etc., of a disk holder 7a on which the recording disk 11 is placed, to the outer periphery.

The rotor magnet 9 is fixed to the hub 7 on the axial lower side of the disk holder 7a, and constitutes a magnetic circuit along with a stator 10 (discussed below).

The recording disk 11 is placed on the disk holder 7a. Further, the recording disk 11 is pressed toward the axial lower side by a damper 13 fixed by a screw 14 on the axial upper side of the shaft 2, and is clamped between the damper 13 and the disk holder 7a.

The stationary member 32 is made up primarily of a base 8 and the stator 10, which is fixed to the base 8.

The base 8 is fixed to the housing of a recording and reproducing apparatus (not shown), or forms part of the housing and constitutes the base portion of the spindle motor 30. The base 8 has a cylindrical part 12 that extends inward radially to the axial upper side, and the cylindrical part 12 fixes the fluid bearing device 40 (discussed below) to the inner peripheral side.

The stator 10 is wound with a coil, serves to constitute a magnetic circuit with the rotor magnet 9, and is disposed across from the rotor magnet 9 to the radial outside. Here, an inner rotor type is described, in which the rotor magnet 9 is disposed around the inner periphery of the stator 10, but the same applies to an outer rotor type, in which the rotor magnet is disposed around the outer periphery of the stator.

The fluid bearing device 40 is fixed to the cylindrical part 12 formed in the middle portion of the base 8, and supports the rotating member 31 rotatably with respect to the stationary member 32.

### Structure of Fluid Bearing Device 40

The fluid bearing device 40 is made up primarily of a sleeve 1, the shaft 2, a thrust plate 4, and oil 6 that serves as a lubricating fluid. Of these, the sleeve 1 and fluid bearing device 40 constitute the stationary member, and the shaft 2 constitutes the rotating member.

### Sleeve 1

The sleeve 1 is a substantially cylindrical member extending in the axial direction and formed from stainless steel, a copper alloy and sintered metal, or the like, for example, and is fixed by adhesive bonding or the like to the base 8. A bearing hole 1a extending in the axial direction is formed in the center part of the sleeve 1. A substantially circular opening is formed at the lower end of the sleeve 1, and the thrust plate 4 is fixed so as to block off this opening.

The sleeve 1 also has a stepped component 1c at its lower end in the axial direction, and a flange 3 (discussed below) is accommodated in the clearance between this stepped component 1c and the thrust plate 4.

A communicating hole 1d is also formed in the sleeve 1. More specifically, the communicating hole 1d is a through-hole extended in the axial direction at a position in the radial center of the sleeve 1, and communicates between the upper and lower faces of the sleeve 1. Further, a plurality of the communicating holes 1d may be provided in the circumferential direction.

An annular seal cap 15 is also provided on the axial upper side of the sleeve 1.

### Shaft 2

The shaft 2 is a stepped, cylindrical member formed from stainless steel or the like, and is made up primarily of a shaft main component 5 and the flange 3, which is formed integrally and concentrically with the shaft main component 5.

### Shaft Main Component 5

The upper end of the shaft main component 5 is formed in a smaller diameter, the hub 7 is fixed to the outer periphery of the upper end, and the shaft main component 5 supports the hub 7 rotatably with respect to the stationary member 32. The shaft main component 5 is inserted into the bearing hole 1a of the sleeve 1, and is disposed a microscopic gap away from the inner peripheral face of the bearing hole 1a. At least one set of radial hydrodynamic grooves 2b are formed in the outer peripheral face of the shaft main component 5. For instance the radial hydrodynamic grooves 2b have a herringbone pattern that is vertically asymmetric in the axial direction. A radial bearing component 21 that supports the shaft 2 radially is constituted by these radial hydrodynamic grooves 2b and the oil 6 that fills the clearance between the inner peripheral face of the bearing hole 1a and the outer peripheral face of the shaft main component 5.

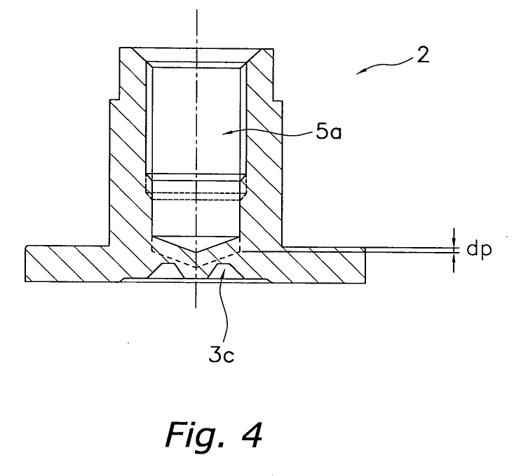

A bottomed screw hole 5a is formed in the shaft main component 5, from the center of the end face on the axial upper side toward the axial lower side. The screw hole 5a is produced by drilling a bottomed pilot hole, and then forming threads by tapping. Therefore, the bottom of the screw hole 5a is formed in a conical shape having an opening angle corresponding to the tip angle of the drill bit being used. A chamfer 5b is formed around the edge of the screw hole 5a on the axial upper side. The chamfer 5b is an annular inclined face whose diameter increases toward the axial upper side, and it is machined to an opening angle of 90±2.0 degrees. This chamfer 5b is the portion that the headstock center hits in the cylindrical grinding (or cylindrical polishing) of the shaft 2 (discussed below). If high coaxial precision of the cylindrical grinding is required, then the chamfer 5b is finished by reaming and polishing. Furthermore, as shown in FIG. 4, a bottomed screw hole (the bottomed hole) 5a and/or a pilot hole (the bottomed hole) for the screw hole 5a are formed in the shaft main component 5 down to a location that is about a depth dp deeper than the joined portion of the shaft main component 5 and the flange 3 (discussed below). In other words, in this embodiment, in the cross section shown in FIG. 4, the screw hole 5a and/or a pilot hole for the screw hole 5a are formed in the shaft main component 5 at a length that reaches farther in from the axial upper side than the portion on the lower axial side where the flange 3 is formed. This allows the location of the bottom part of the screw hole 5a and/or a pilot hole for the screw hole 5a to be moved lower in the axial direction than in the past, so the overall length of the shaft main component can be shortened, and the device can be made more compact.

### Flange 3

The flange 3 is a portion with a larger diameter than the shaft main component 5, formed integrally at the end face of the shaft main component 5 on the axial lower side. At least one set of thrust hydrodynamic grooves 3a are formed in the end face of the flange 3 on the axial lower side. The thrust hydrodynamic grooves 3a have a spiral or herringbone pattern, for example. A thrust bearing component 22 that supports the shaft 2 in the axial direction is constituted by these thrust hydrodynamic grooves 3a and the oil 6 that fills the clearance between the end face of the flange 3 on the axial lower side and the end face of the thrust plate 4 on the axial upper side.

A stepped component 3b that is recessed toward the axial upper side is formed in the end face of the flange 3 on the axial lower side, more to the radial inside from the radial region in which the thrust hydrodynamic grooves 3a are formed. The stepped component 3b are recessed by about 0.05 to 0.1 mm in the axial direction from the end face in which the thrust hydrodynamic grooves 3a are formed. Further, an annular concave component 3c that is recessed toward the axial upper side is formed on the inner peripheral side of the stepped component 3b. The annular concave component 3c is formed coaxially with the screw hole 5a.

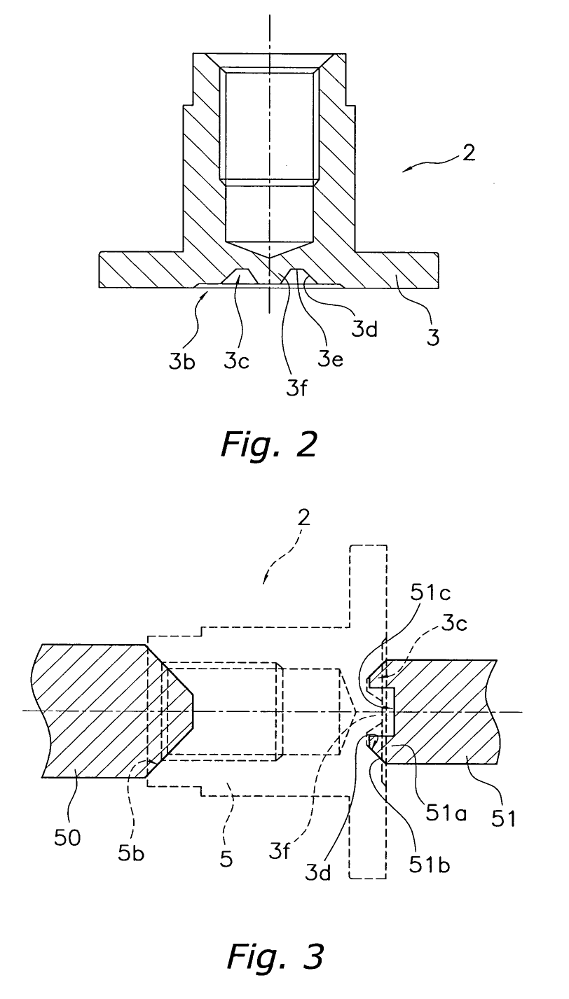

The annular concave component 3c will be described through reference to FIG. 2.

The annular concave component 3c is a recess formed by a chamfer 3d that is continuous with the stepped component 3b and whose diameter decreases toward the axial upper side, an annular bottom component 3e that extends from the inner peripheral side of the chamfer 3d toward the radial inside, and a middle portion 3f that protrudes from the bottom component 3e toward the axial lower side. The chamfer 3d is an annular inclined face whose diameter decreases toward the axial upper side, and it is machined to an opening angle of 90±2.0 degrees. This chamfer 3d is the portion that the tailstock center hits in the cylindrical grinding (or cylindrical polishing) of the shaft 2 (discussed below). If high coaxial precision of the cylindrical grinding is required, then the chamfer 3d is finished by reaming and polishing.

The shaft 2 (see FIG. 1), which is a member on the rotating side constituted as above, is combined with the member on the stationary side by inserting the shaft main component 5 into the bearing hole 1a of the sleeve 1, and placing the flange 3 in the clearance bounded by the thrust plate 4 and the stepped component 1c of the sleeve 1.

The shaft main component 5 and the flange 3 were formed integrally in the shaft 2 above, but may instead be attached separately. Also, the radial hydrodynamic grooves 2b may be formed in the inner peripheral face of the bearing hole 1a across from the outer peripheral face of the shaft main component 5. Also, the thrust hydrodynamic grooves 3a may be formed in the end face of the thrust plate 4 on the axial upper side, across from the end face of the flange 3 on the axial lower side.

The structure of the annular concave component 3c is not limited to the above. For instance, the annular bottom component 3e may be constituted by an annular curved face that continuously connects the chamfer 3d with the middle portion 3f.

### Cylindrical Grinding

The cylindrical grinding of the shaft 2 will be described through reference to FIG. 3. The cylindrical grinding of the shaft 2 is performed to polish the outer peripheral face of the shaft main component 5 in which the radial hydrodynamic grooves 2b are formed, and to cut out the shaft 2.

This cylindrical grinding involves grinding the outer peripheral face of the shaft 2 (the workpiece) with a grinder (not shown). With this grinder, the two axial ends of the shaft 2 are supported by a headstock center 50 that imparts rotational motion to the shaft 2, and a tailstock center 51 that supports the shaft 2 across from the headstock center 50, and the outer peripheral face of the shaft main component 5 is cut away with a grindstone that is rotating at high speed.

The tip of the headstock center 50 is formed in a substantially conical shape (substantially a conical frustum), and its opening angle is 95±0.5°. The headstock center 50 hits the chamfer 5b of the shaft main component 5, and the opening angle of the chamfer 5b is 90±2.0° as mentioned above. Therefore, the headstock center 50 is able to hit the chamfer 5b relatively to the outside in the radial direction. The opening angle of the substantially conical tip of the headstock center 50 is not limited to the above, however, and the desired effect will be obtained as long as the angle is greater than the opening angle of the chamfer 5b including variance.

An annular convex component 51a that protrudes in an annular shape corresponding to the annular concave component 3c of the shaft 2 is formed at the tip of the tailstock center 51. The outer peripheral face 51b of the annular convex component 51a forms part of the lateral face of an imaginary cone, and is constituted by an inclined face whose diameter decreases toward the tip. Further, a middle concave component 51c that accommodates a middle portion 3f protruding in the middle of the annular concave component 3c is formed in the center of the annular convex component 51a. The opening angle of the outer peripheral face 51b is 95±0.5°. The tailstock center 51 hits the chamfer 3d of the annular concave component 3c, and the opening angle of the chamfer 3d is 90±2.0° as mentioned above. Therefore, the tailstock center 51 is able to hit the chamfer 3d relatively to the outside in the radial direction. The opening angle of the outer peripheral face 51b of the tailstock center 51 is not limited to the above, however, and the desired effect will be obtained as long as the angle is greater than the opening angle of the chamfer 3d including variance.

Further the middle concave component 51c ensures enough clearance to accommodate the middle portion 3f of the annular concave component 3c, and also acts as a grinding oil reservoir during cylindrical grinding.

### Thrust Plate 4

The thrust plate 4 (see FIG. 1), as discussed above, is attached to the inner peripheral side of the sleeve 1 on the axial lower side. The thrust bearing component 22 is formed in the clearance between the thrust plate 4 and the end face of the flange 3 on the axial lower side.

### Oil 6

The oil 6 fills the gap formed between the thrust plate 4, the shaft 2, and the sleeve 1, including the radial bearing component 21 and the thrust bearing component 22, the gap between the seal cap 15 and the top face of the sleeve 1 in the axial direction and the communicating hole Id formed in the sleeve 1, and so forth.

Also, because the radial hydrodynamic grooves 2b formed in the radial bearing component 21 are asymmetric in the axial direction, the oil 6 generates pumping force downward in the axial direction, for example, and as a result, the oil circulates through the bearing under the circulating force oriented downward in the axial direction.

A low-viscosity ester oil or the like can be used as the oil 6, for example. Another high-fluidity grease or ionic fluid may also be used as the oil 6.

### Operation of the Spindle Motor 30

With the spindle motor 30, a rotational magnetic field is generated when power is sent to the stator 10, and a rotational force is imparted to the rotor magnet 9. This allows the rotating member 31 to be rotated along with the shaft 2, with the shaft 2 as the rotational center.

When the shaft 2 rotates, support pressure in the radial and axial directions is generated in the hydrodynamic grooves 2b and 3a. Consequently, the shaft 2 is supported in a state of non-contact with the sleeve 1. Specifically, the rotating member 31 is able to rotate in a state of non-contact with the stationary member 32, and this allows the recording disk 11 to rotate precisely and at a high speed.

### Effect

(1)

With the fluid bearing device 40, since the annular concave component 3c is formed in the end face of the shaft 2 on the axial lower side, the center of the end face of the shaft 2 on the axial lower side can be made thicker with keeping airtight. Accordingly, enough thickness can be ensured at the bottom part of the screw hole 5a even if the length of the screw hole 5a in the axial direction is increased as indicated by the broken line in FIG. 4. In particular, as shown in FIG. 4, the bottom part of the screw hole 5a and/or a pilot hole for the screw hole 5a are formed farther in by a depth of dp than the portion of the shaft 2 that is joined with the flange 3, in the axial direction of the shaft 2. This allows the location of the bottom part of the screw hole 5a and/or a pilot hole for the screw hole 5a to be moved lower in the axial direction than in the past. Specifically, by shortening the axial length of the shaft 2, the device can be made more compact while maintaining or increasing the length of the screw hole 5a, and the screw 14 can be tightened more securely into the screw hole 5a. This raises the clamping force on the recording disk 11, and allows impact resistance to be maintained or improved.

Also, since enough thickness can be ensured at the bottom part of the screw hole 5a, the screw hole 5a can be prevented from penetrating to the thrust bearing component 22, and it is possible to prevent the occurrence of problems such as a decrease in the pressure of the bearing, or a decrease in the amount of oil in the bearing to the point that the bearing cannot perform its function, or leakage of the oil 6 outside the bearing and attendant fouling of the recording and reproducing apparatus in which the fluid bearing device 40 is installed.

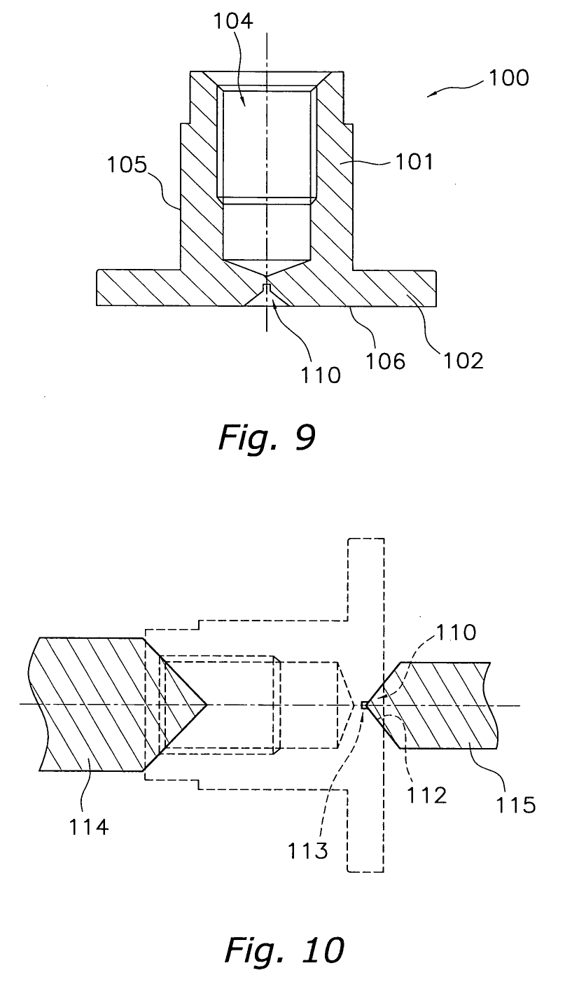

Also, since the annular concave component 3c, which has a larger volume than the conventional center hole 110 (see FIG. 9), is provided in the middle of the end face of the shaft 2 on the axial lower side, more of the abrasion dust that has been entrained into the oil 6, and residue of the oil 6, can be trapped. Also, since it is possible for the annular concave component 3c to have a larger volume the conventional center hole 110, it can act as an oil reservoir for the oil 6, and this extends the service life of the bearing.

(2)

With the fluid bearing device 40, the chamfer 3d, which is an annular inclined face, is formed in the annular concave component 3c (see FIG. 3). Further, the opening angle of the chamfer 3d is smaller than the opening angle of the tailstock center 51. Accordingly, the tailstock center 51 is able to hit the outer peripheral side of the chamfer 3d, so it is possible to support the shaft 2 more stably during cylindrical grinding.

Also, the chamfer 5b, which is an annular inclined face, is formed in the screw hole 5a. Further, the opening angle of the chamfer 5b is smaller than the opening angle of the headstock center 50. Accordingly, the headstock center 50 is able to hit the outer peripheral side of the chamfer 5b, so it is possible to support the shaft 2 more stably during cylindrical grinding.

(3)

With the fluid bearing device 40, the annular concave component 3c is formed on the inner peripheral side of the stepped component 3b formed at a different level from the face where the thrust hydrodynamic grooves 3a are formed (see FIG. 2). Accordingly, even if burrs or the like should be left behind in the machining of the annular concave component 3c, they will not affect the bearing face, and it will be possible to prevent these burrs from wearing against the thrust plate 4 and finding their way into the lubricating fluid as abrasion dust.

(4)

Because the spindle motor 30 is equipped with the fluid bearing device 40, the same effects as those discussed above can be obtained.

(5)

Because the tailstock center 51 has the annular convex component 51a at its tip, even a workpiece such as the shaft 2 that is difficult to work by centerless machining can undergo suitable cylindrical grinding (or cylindrical polishing).

(6)

The tips of the headstock center 50 and the tailstock center 51 have an opening angle that is larger than those of the chamfer 3d and the chamfer 5b that make contact during cylindrical grinding, so it is possible to support the chamfer 3d and the chamfer 5b more to the outer peripheral side. Accordingly, with a grinder equipped with the headstock center 50 and the tailstock center 51, it is possible to machine the shaft 2 more stably.

(7)

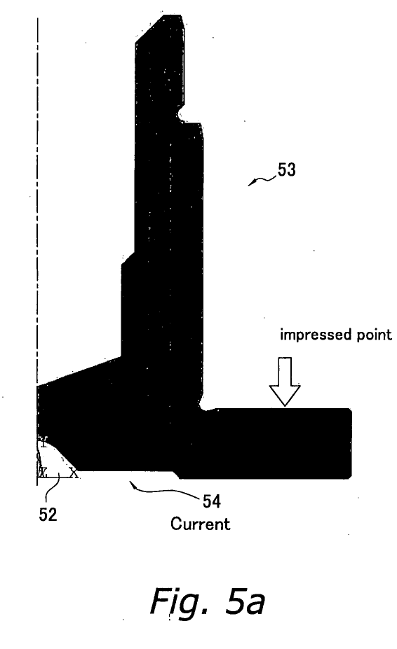

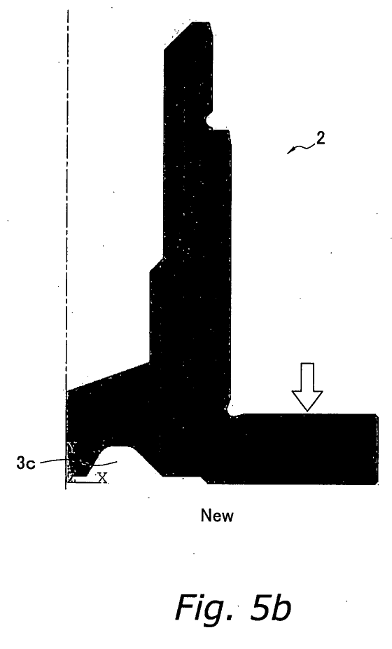

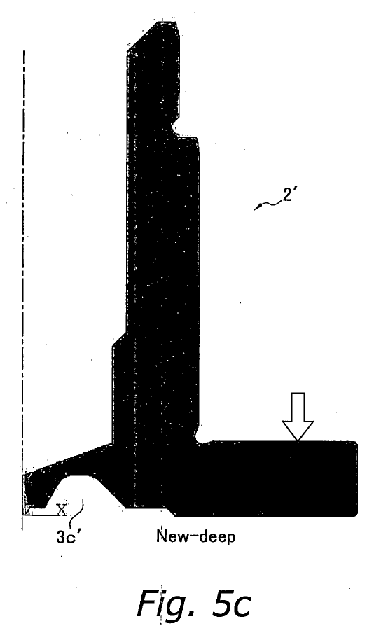

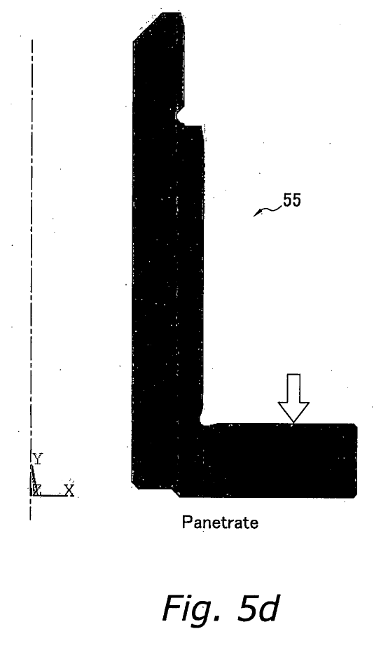

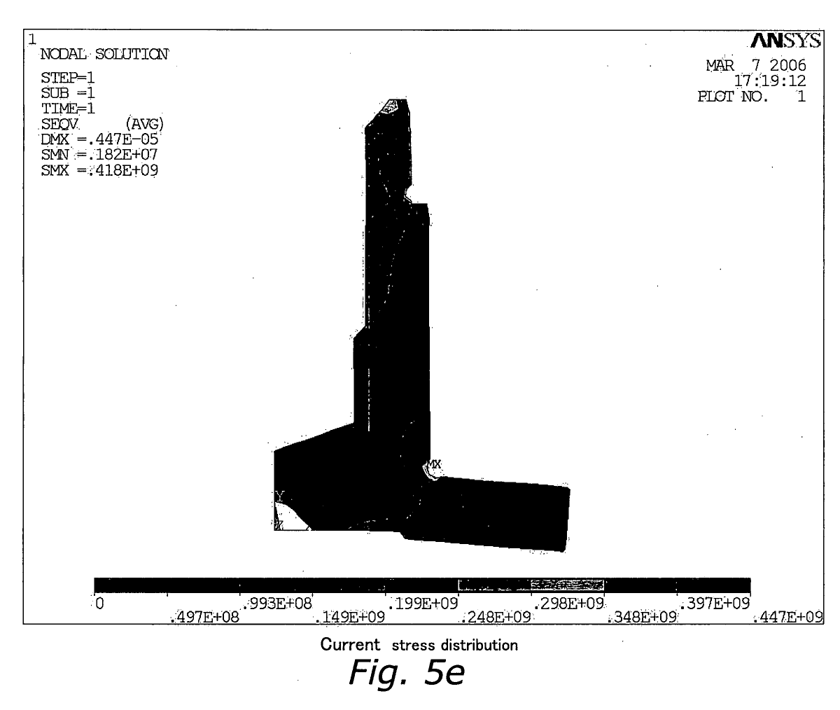

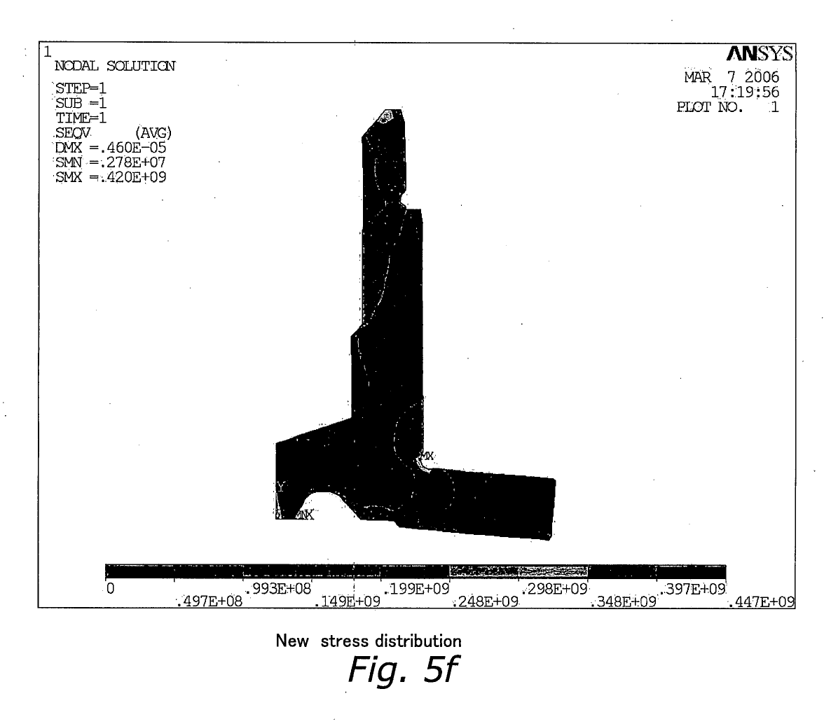

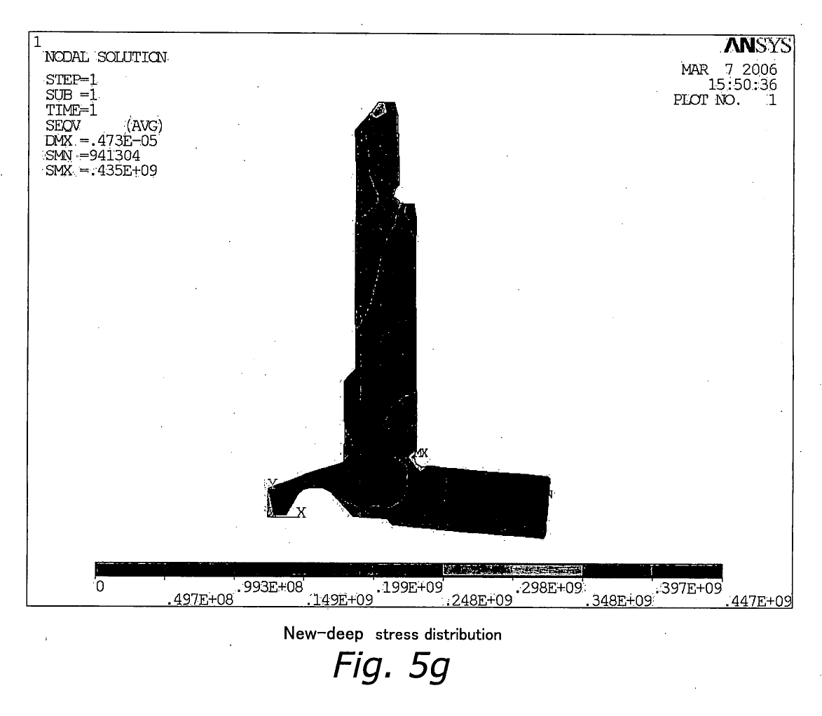

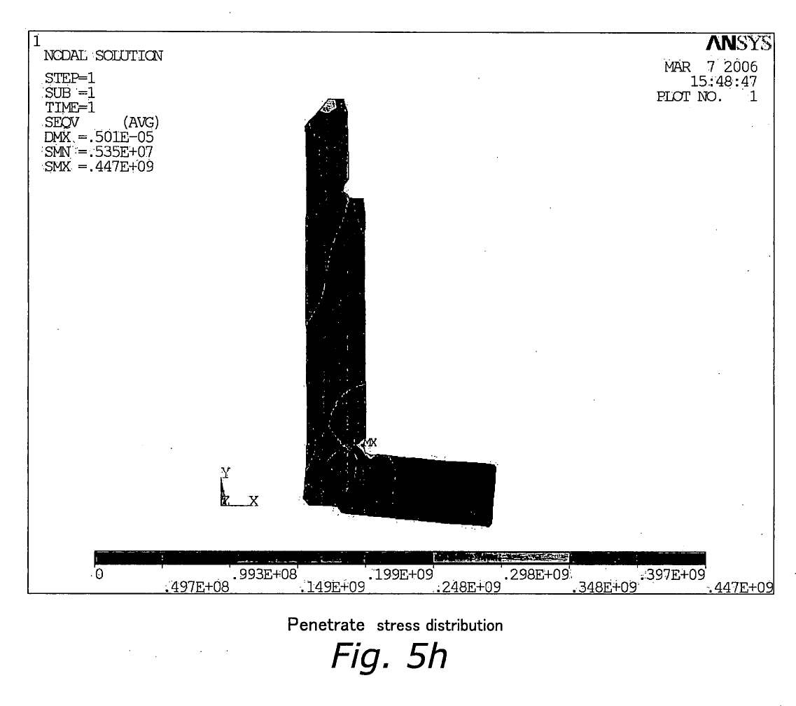

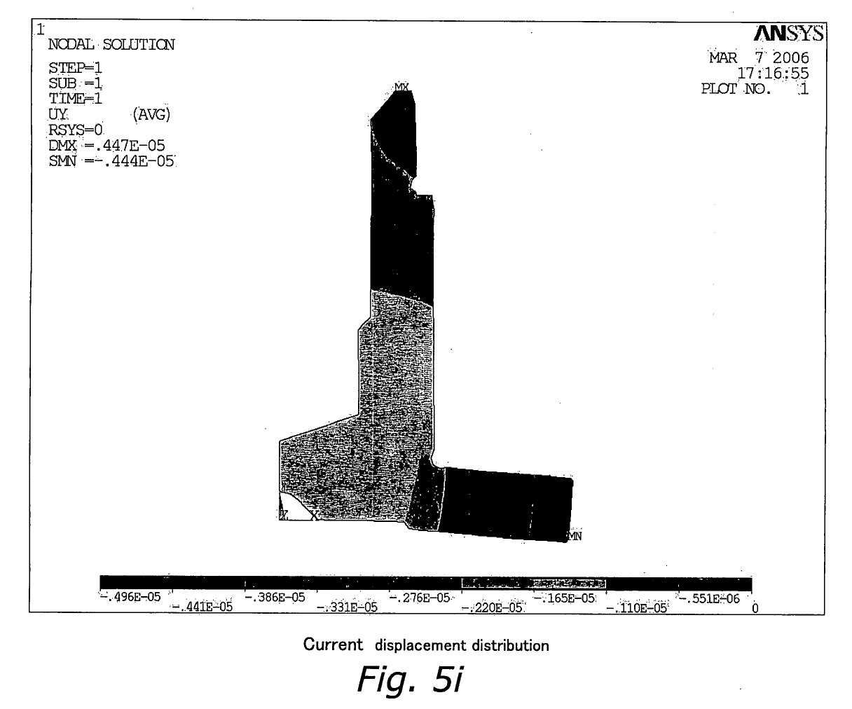

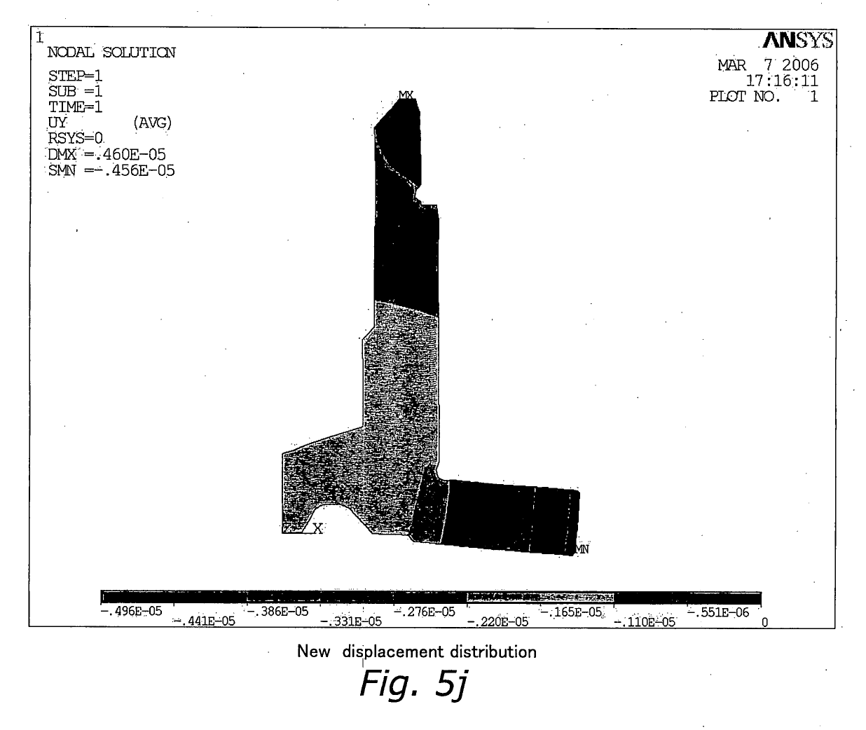

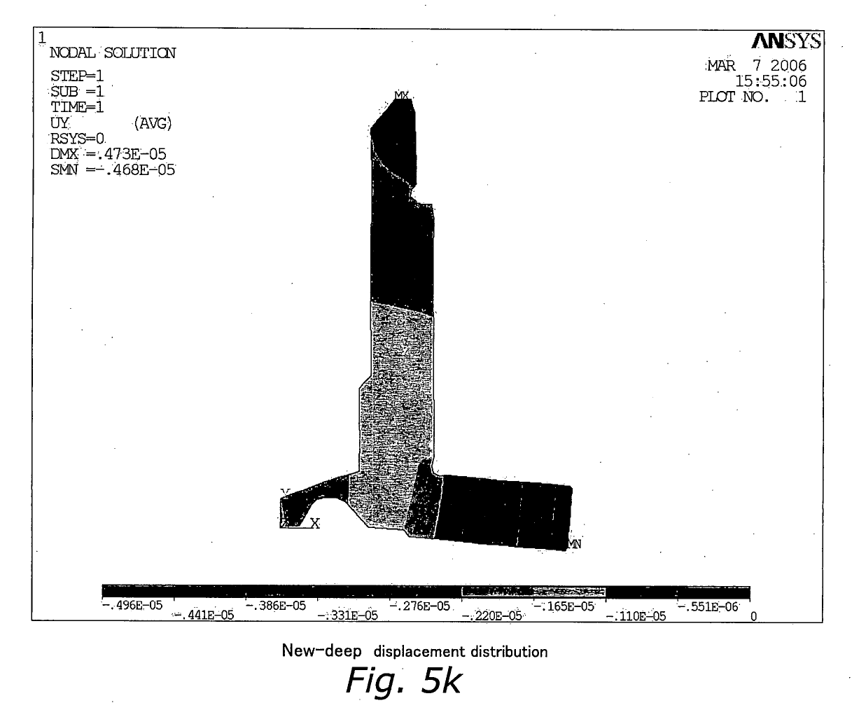

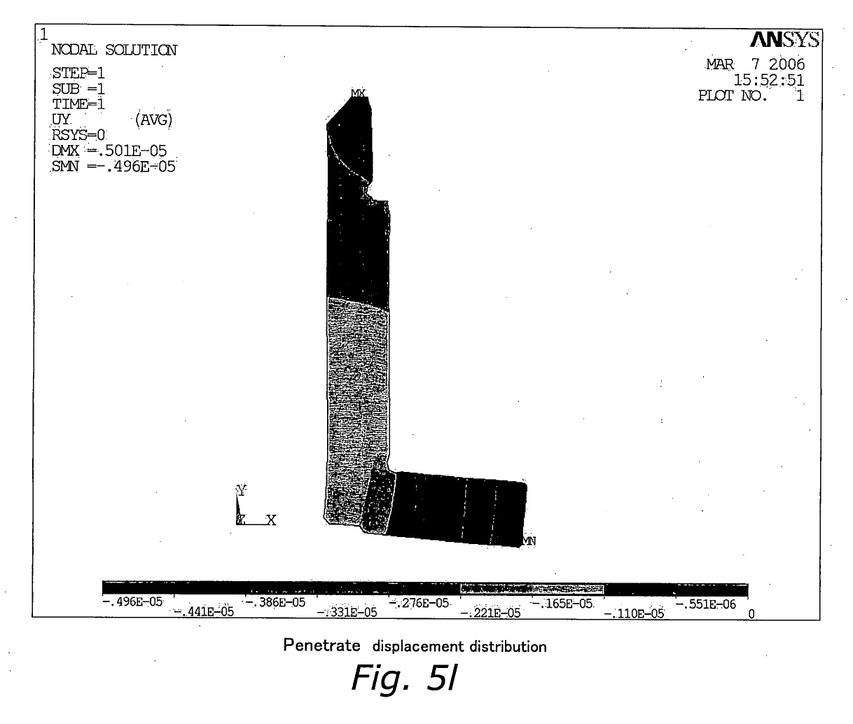

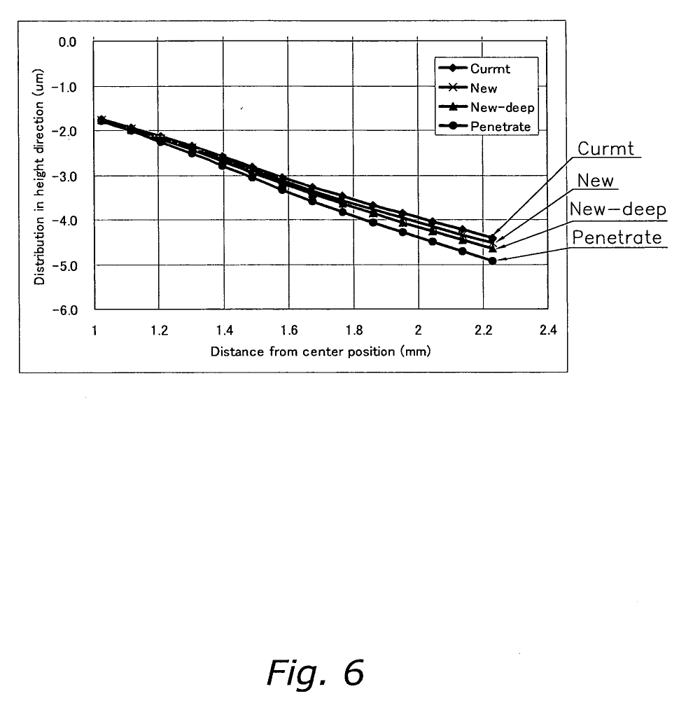

With the spindle motor 30, it is necessary to meet the requirements for good impact resistance and higher clamping force by increasing the effective thread length of the screw hole 5a. In particular, it is desirable for the effective thread length to be increased over that of a conventional structure while the stiffness of the shaft 2 is maintained. FIGS. 5a to 5d and 6 show the results of a simulation related to this. FIG. 6 shows the displacement of the flange in the axial direction when the distance from the center of the shaft 2 is shifted every 0.092 mm at the beginning of a point 1.025 mm.

FIGS. 5a to 5l and FIG. 6 show the results of simulations conducted for structures of a shaft 53 having a center hole 52 with a conventional structure (Current), the shaft 2 of the present invention having the annular concave component 3c and having the same effective thread length as the shaft 53 (New), the shaft 2′ of the present invention having an annular concave component 3c′ and having an effective thread length that is greater than that of the shaft 53 (New-deep), and a shaft 55 having a screw hole that passes all the way through up and down in the axial direction (Penetrate). With the conventional shaft 100 (see FIG. 9), no stepped component is formed on the outer peripheral side of the center hole 110 at the end face on the axial lower side of the flange 102. However, for the sake of a more accurate comparison, a simulation was conducted using the shaft 53, in which a stepped component 54 was formed, versus the conventional shaft 100 shown in FIG. 9.

FIGS. 5a to 5l show the stress distribution and displacement distribution within the shaft when the axial thickness of the flange was 0.5 mm and a load of approximately 250 N (an impact load of approximately 2000 G) was exerted on the end face on the axial upper side of the flange (the location indicated by the block arrows in the drawings).

FIG. 6 shows the amount of displacement of the end face of the flange on the axial lower side when the same load was exerted. The load exerted on the flange here is the load applied in an operating reliability test conducted on a small HDD. A small HDD needs to operate reliably even under this load.

The stress distribution graphs of FIGS. 5a to 5l show that stress is concentrated at the flange attachment points, and that stress is low around the outer periphery of the flange and in the lower part of the screw hole with each of the structures. However, particularly with the “Current,” “New,” and “New-deep” shown in FIGS. 5a to 5i, stress distribution and displacement distribution both exhibit similar tendencies. Also, since the stress is relatively low in the lower part of the screw hole, it can be seen that forming the annular concave component 3c of the present invention will have little effect on the stress distribution. The stress is high at the tip of the shaft, but this is because this portion is constricted in the simulation.

Also, the displacement distribution graphs of FIGS. 5a to 5l show that displacement increases toward the outer peripheral part of the flange in each of the structures.

Also, as can be seen in FIG. 6, in the “Current” scenario, there is deformation of approximately 4.0 μm at a point 2 mm from the axial center. In contrast, in the “New” and “New-deep” scenarios, it can be seen that roughly the same amount of deformation is exhibited at the same point, and that the stiffness is roughly the same as that in “Current.” Specifically, even when the annular concave component 3c or 3c′ of the present invention is provided, substantially the same stiffness can be maintained as with a conventional structure, and as shown in “New-deep,” the effective thread length can be increased and the clamping force raised.

Meanwhile, with the “Penetrate” scenario, the deformation is approximately 4.4 μm at the same point. This indicates that when the screw hole goes all the way through and an impact load is applied to the flange, only a small portion generates resistance to the deformation, so deformation readily occurs. Specifically, it can be seen that with a conventional center hole structure, if the screw hole is allowed to pass through so that the effective thread length have to be increased, the stiffness of the shaft decreases. In this case, it is possible that air-tightness could be ensured or reinforcement achieved by blocking the through-hole with a separate member, for example, but it is more difficult to reliably maintain air-tightness, and the shaft manufacturing process becomes more complicated, which drives up the cost.

As can be seen from the above, providing the annular concave component 3c or 3c′ of the present invention allows the effective thread length to be increased, while maintaining the stiffness of the shaft and also ensuring air-tightness.

### Other Embodiments

Embodiments of the present invention were described above, but the present invention is not limited to the above embodiments, and various modification are possible without deviating from the scope of the invention.

(A)

A convex component protruding to the axial lower side may be formed in the end face of the flange 3 on the axial lower side in order to prevent contact wear during start-up or shut-down between the thrust plate 4 and the face in which the thrust hydrodynamic grooves 3a are formed. The convex component may have arc-shaped protrusions arranged in the peripheral direction, provided on the inner peripheral side of the thrust hydrodynamic grooves 3a, and on the outer peripheral side of the stepped component 3b.

When this convex component is formed, contact wear between the thrust plate 4 and the face in which the thrust hydrodynamic grooves 3a are formed can be prevented, and this extends the service life of the bearing.

(B)

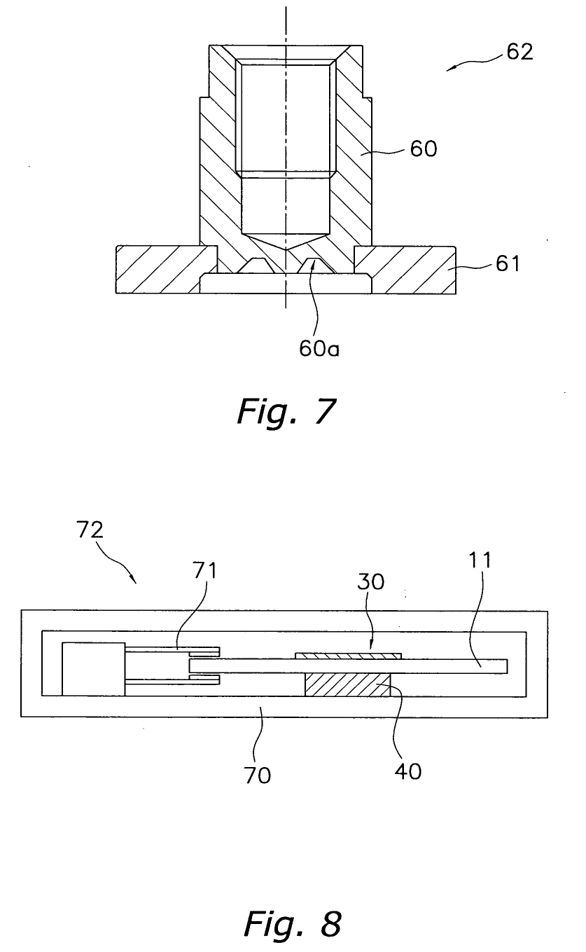

In the above embodiments, the shaft 2 was formed integrally, but even when the shaft main component 5 and the flange 3 are formed separately, and are fixed by welding or the like, it is still preferable to provide the annular concave component 3c of the present invention. FIG. 7 shows the structure of a shaft 62 in which a shaft main component 60 and a flange 61 are formed separately and are fixed by welding. In this case, the outer peripheral face of the shaft main component 60 is most often polished ahead of time, prior to the welding. However, the welding may cause deformation in the flange 61 and so forth, so that polishing is required for the end face of the flange 61 on the axial upper side. In this case, an annular concave component 60a that is the same as that described in the above embodiments may be formed in the end face of the shaft main component 60 on the axial lower side, and the shaft 62 can be cylindrical ground using this annular concave component 60a as a center hole.

(C)

In the above embodiments, the thrust bearing component 22 was described as being located between the flange 3 and the thrust plate 4. However, the thrust bearing component may instead be located between the end face of the flange 3 on the axial upper side and the end face of the opposing sleeve 1 on the axial lower side, or may be in both of these locations.

(D)

In the above embodiments, the description was of an example in which the present invention was applied to the fluid bearing device 40 and the spindle motor 30. However, the present invention is not limited to this.

For instance, as shown in FIG. 8, the present invention can also be applied to a recording and reproducing apparatus 72 in which a fluid bearing device 40 and spindle motor 30 having the structures described above are installed in a housing 70, and information recorded to a recording disk 11 by a recording head 71 is reproduced, or information is recorded to the recording disk 11.

(E)

In the above embodiments, the description was of an example in which the shaft 2 had the flange 3 or the flange 61. However, the present invention is not limited to this.

For instance, as shown in FIGS. 2 and 7, centerless polishing is possible with a flangeless type of shaft having no flange, and the same effect as above can be obtained when the present invention is applied to a flangeless type of shaft.

### INDUSTRIAL APPLICABILITY

The present invention provides a hydrodynamic bearing that meets the requirements for compact size and impact resistance, and is therefore useful as a spindle motor used in portable or onboard applications, or as a recording and reproducing apparatus in which this spindle motor is used.

What is claimed is:

1. A hydrodynamic bearing device, comprising:
a sleeve in which an insertion hole is formed;
a shaft having a shaft main component that is inserted in the insertion hole, and a flange component provided to one side in the axial direction of the shaft main component;
a thrust plate that is fixed to the sleeve and covers the shaft from the one side in the axial direction;
a radial bearing component including a lubricating fluid that continuously fills in between the sleeve and the shaft and in between the shaft and the thrust plate, and a radial hydrodynamic groove that is formed in the outer peripheral face of the shaft main component and/or in the inner peripheral face of the insertion hole, and that supports the shaft so that the shaft is rotatable relative to the sleeve; and
a thrust bearing component including the lubricating fluid that continuously fills in between the sleeve and the shaft and in between the shaft and the thrust plate, and a thrust hydrodynamic groove that is formed in the end face of the shaft on the one side in the axial direction and/or in the end face of the thrust plate on the other side in the axial direction, and that supports the shaft so that the shaft is rotatable relative to the sleeve,
wherein a bottomed hole that is coaxial with the shaft main component is formed in the shaft main component from the end face on said other side in the axial direction toward said one side in the axial direction, and
an annular concave component that is coaxial with the shaft is formed in the end face on said one side in the axial direction of the shaft.

2. The hydrodynamic bearing device according to claim 1,
wherein the inner peripheral face on the radial outside of the annular concave component is an inclined face whose diameter increases toward said one side in the axial direction.

3. The hydrodynamic bearing device according to claim 1,
wherein a stepped component that is recessed toward said other side in the axial direction is formed to the radial inside of the end face on said one side in the axial direction of the shaft, and
the annular concave component is formed on the radial inner peripheral side of the stepped component.

4. The hydrodynamic bearing device according to claims 1,
wherein a convex component that protrudes to said one side in the axial direction, to the radial outside of the annular concave component, is formed on the end face on said one side in the axial direction of the shaft.

5. The hydrodynamic bearing device according to claims 1,
wherein the bottomed hole is formed in the axial direction in the shaft main component, more toward the end on said one side in the axial direction with respect to a joined portion with the flange component on said one side in the axial direction.

6. A motor, comprising:
the hydrodynamic bearing device according to claims 1;
a base to which the sleeve is fixed;
a stator that is fixed to the base;
a rotor magnet that is disposed across from the stator and constitutes a magnetic circuit along with the stator; and
a hub to which the rotor magnet is fixed, and which is fixed to the shaft.

7. A recording and reproducing apparatus, comprising:
the motor according to claim 6;
a disk-shaped recording medium that is fixed to the hub and allows information to be recorded; and
information access means for writing or reading information to a specific location of the recording medium.

8. A machining jig for supporting a workpiece during the cylindrical cutting or cylindrical polishing of the workpiece, comprising:
a first-side support component that has an annular convex component that mates with an annular concave component formed in the end face on said one side in the axial direction of the workpiece, and that supports the workpiece from said one side in the axial direction; and
a second-side support component that supports the workpiece from said other side in the axial direction.

9. The machining jig according to claim 8,
wherein the annular concave component has an inner peripheral inclined face whose diameter increases toward said one side in the axial direction,
the annular convex component has an outer peripheral inclined face whose diameter increases toward said one side in the axial direction, and
the outer peripheral inclined face has an opening angle that is larger than that of the inner peripheral inclined face.

10. A hydrodynamic bearing device, comprising:
a sleeve in which an insertion hole is formed;
a shaft that is inserted into the insertion hole;
a thrust plate that is fixed to the sleeve and covers the shaft from one side in the axial direction;
a radial bearing component including a lubricating fluid that continuously fills in between the sleeve and the shaft and in between the shaft and the thrust plate, and a radial hydrodynamic groove that is formed in the outer peripheral face of the shaft and/or in the inner peripheral face of the insertion hole, and that supports the shaft so that the shaft is rotatable relative to the sleeve; and
a thrust bearing component including the lubricating fluid that continuously fills in between the sleeve and the shaft and in between the shaft and the thrust plate, and a thrust hydrodynamic groove that is formed in the end face of the shaft on the one side in the axial direction and/or in the end face of the thrust plate on the other side in the axial direction, and that supports the shaft so that the shaft is rotatable relative to the sleeve, wherein a bottomed hole that is coaxial with the shaft is formed in the shaft from the end face on said other side in the axial direction toward said one side in the axial direction, and
an annular concave component that is coaxial with the shaft is formed in the end face on said one side in the axial direction of the shaft.
